(19) United States
(12) Patent Application Publication
(10) Pub. No.: US 2018/0082479 A1
(43) Pub. Date: Mar. 22, 2018

(54) VIRTUAL FITTING METHOD, VIRTUAL FITTING GLASSES AND VIRTUAL FITTING SYSTEM

(71) Applicant: BOE TECHNOLOGY GROUP CO., LTD., Beijing (CN)

(72) Inventor: Jingyu ZHANG, Beijing (CN)

(73) Assignee: BOE TECHNOLOGY GROUP CO., LTD., Beijing (CN)

(21) Appl. No.: 15/694,018

(22) Filed: Sep. 1, 2017

(30) Foreign Application Priority Data
Sep. 22, 2016 (CN) 201610844709.9

(51) Int. Cl. G06T 19/00

(52) U.S. Cl. CPC G06T 19/006

(57) ABSTRACT

A virtual fitting method, a pair of virtual fitting glasses and a virtual fitting system are provided. The virtual fitting method includes: acquiring characteristic data of a target piece of clothing and acquiring an image of the target piece of clothing based on the characteristic data; combining the image of the target piece of clothing with a body feature image of a user, to obtain a fitting image of the user wearing the target piece of clothing; and displaying the fitting image.

### CROSS-REFERENCE TO RELATED APPLICATION

This application claims priority to Chinese Patent Application No. 201610844709.9 filed Sep. 22, 2016, which is incorporated herein by reference in its entirety.

### TECHNICAL FIELD

The present disclosure relates to the field of display technology, and in particularly to a virtual fitting method, a pair of virtual fitting glasses and a virtual fitting system.

### BACKGROUND

When people buy clothes at a shopping mall, they may try on the clothes they like to buy their desired clothes. A user may change clothes continually when trying on the clothes, so as to find the best fitting effect clothes. However, it is a waste of time and energy for the user to change clothes continually.

### SUMMARY

The present disclosure provides a virtual fitting method, a pair of virtual fitting glasses and a virtual fitting system in at least one embodiment of the present disclosure, to save time and energy of the user when trying on the clothes.

To achieve the above objective, the present disclosure provides the following solutions.

A virtual fitting method is provided in at least one embodiment of the present disclosure, including: acquiring characteristic data of a target piece of clothing and acquiring an image of the target piece of clothing based on the characteristic data; combining the image of the target piece of clothing with a body feature image of a user, to obtain a fitting image of the user wearing the target piece of clothing; and displaying the fitting image.

Optionally, prior to acquiring the characteristic data of the target piece of clothing and acquiring the image of the target piece of clothing based on the characteristic data, the method further includes: acquiring characteristic data of a plurality of pieces of clothing; retrieving costume preference data of the user; and in the case that the characteristic data of a certain piece of clothing among the pieces of clothing matches the costume preference data, marking the certain piece of clothing with an icon.

Optionally, in the case that the characteristic data of the target piece of clothing is a trademark or a two-dimensional code, the acquiring the characteristic data of the target piece of clothing and acquiring the image of the target piece of clothing based on the characteristic data includes: scanning the trademark or the two-dimensional code, and retrieving an image of the clothing matching the trademark or the two-dimensional code from a remote server.

Optionally, in the case that the characteristic data of the target piece of clothing are a color and a size of the target piece of clothing, the acquiring the image of the target piece of clothing based on the characteristic data includes: generating the image of the target piece of clothing based on the characteristic data.

Optionally, subsequent to displaying the fitting image, the method further includes: receiving a storage instruction from the user, and storing the characteristic data of the target piece of clothing in the fitting image as costume preference data of the user.

A pair of virtual fitting glasses is provided in at least one embodiment of the present disclosure, including a glasses bracket and an acquisition unit, a processor and a display arranged on the glasses bracket, where the acquisition unit is arranged at a side of the glasses bracket away from user's eyes, and configured to acquire characteristic data of a target piece of clothing and acquire an image of the target piece of clothing based on the characteristic data; the processor is connected to the acquisition unit, and configured to combine the image of the target piece of clothing with a body feature image of a user to obtain a fitting image of the user wearing the target piece of clothing; and the display is connected to the processor and configured to display the fitting image.

Optionally, the pair of virtual fitting glasses further includes a storage arranged on the glasses bracket and configured to store therein the body feature image of the user and costume preference data of the user.

Optionally, the fitting image is a two-dimensional image, the display includes a transparent prism and a projector arranged on a glasses temple of the glasses bracket, and the projector is configured to project the fitting image onto the transparent prism to project via the transparent prism the fitting image to the user eye.

Optionally, the fitting image is a three-dimensional image, the display includes a first transparent prism and a first projector arranged on one glasses temple of the glasses bracket and a second transparent prism and a second projector arranged on the other glasses temple of the glasses bracket; the first projector is configured to project a left-eye image of the fitting image onto the first transparent prism to project via the first transparent prism the left-eye image to a user's left eye; and the second projector is configured to project a right-eye image of the fitting image onto the second transparent prism to project via the second transparent prism the right-eye image to a user's right eye.

Optionally, the pair of virtual fitting glasses further includes a positioner arranged on the glasses bracket and configured to detect a geographic position of the user.

Optionally, the acquisition unit includes a data call integrated circuit and a charge-coupled device (CCD) camera or a complementary metal oxide semiconductor (CMOS) camera connected to the data call integrated circuit; the CCD camera or the CMOS camera is configured to scan a trademark or a two-dimensional code of the target piece of clothing; and the data call integrated circuit is configured to retrieve, based on the trademark or the two-dimensional code of the target piece of clothing, an image of the clothing matching the trademark or the two-dimensional code from a remote server.

Optionally, the acquisition unit includes a depth camera configured to acquire a color and a size of the target piece of clothing and generate the image of the target piece of clothing based on the color and the size of the target piece of clothing.

Optionally, the pair of virtual fitting glasses further includes a starting switch, where the positioner is further configured to send a starting signal to the starting switch to power on the pair of virtual fitting glasses.

Optionally, the positioner further includes an acceleration sensor, a gyroscope and a magnetism sensor.

Optionally, the depth camera is configured to generate, based on the color and the size of the target piece of clothing, a depth image of the target piece of clothing indicating depth related information.

A virtual fitting system is further provided in at least one embodiment of the present disclosure, including the above pair of virtual fitting glasses and a remote server connected to the pair of virtual fitting glasses.

### BRIEF DESCRIPTION OF THE DRAWINGS

In order to illustrate the technical solutions of the present disclosure or the related art in a clearer manner, the drawings desired for the present disclosure or the related art will be described hereinafter briefly. Obviously, the following drawings merely relate to some embodiments of the present disclosure, and based on these drawings, a person skilled in the art may obtain the other drawings without any creative effort.

FIG. 1 is a flow chart of a virtual fitting method in at least one embodiment of the present disclosure;

FIG. 2 is a flow chart of recommending clothes prior to Step 101 in FIG. 1;

FIG. 3 shows clothes marked with icons in Step 203 in FIG. 2;

FIG. 4 is a schematic view of a pair of virtual fitting glasses in at least one embodiment of the present disclosure;

FIG. 5 is a flow chart of a fitting process with the pair of virtual fitting glasses in FIG. 4;

FIG. 6 is a schematic view of an acquisition unit of the pair of virtual fitting glasses in FIG. 4;

FIG. 7 is a schematic view of a pair of virtual fitting glasses showing a two-dimensional fitting image in at least one embodiment of the present disclosure;

FIG. 8 is a schematic view of an optical principle of the pair of virtual fitting glasses in FIG. 7;

FIG. 9 is a schematic view of a pair of virtual fitting glasses showing a three-dimensional fitting image in at least one embodiment of the present disclosure; and

FIG. 10 is a schematic view of an optical principle of the pair of virtual fitting glasses in FIG. 9.

### DRAWING REFERENCES

10—glasses bracket
101—glasses temple
102—glasses frame
11—acquisition unit
110—data call integrated circuit
111—CCD camera
12—processor
120—transparent prism
121—projector
1201—first transparent prism
1202—second transparent prism
1211—first projector
1212—second projector
13—display
20—virtual fitting glasses
30—remote server

### DETAILED DESCRIPTION

The present disclosure will be described hereinafter in a clear and complete manner in conjunction with the drawings and embodiments. Obviously, the following embodiments merely relate to a part of, rather than all of, the embodiments of the present disclosure, and based on these embodiments, a person skilled in the art may, without any creative effort, obtain the other embodiments, which also fall within the scope of the present disclosure.

A virtual fitting method is provided in at least one embodiment of the present disclosure. As shown in FIG. 1, the method includes:

Step 101: acquiring characteristic data of a target piece of clothing and acquiring an image of the target piece of clothing based on the characteristic data.

It should be noted that, the above target piece of clothing is the one the user want to try on and see the fitting effect.

In addition, the characteristic data of the target piece of clothing may be a color, a size, a style, a two-dimensional code and a trademark, etc.

Moreover, the image of the target piece of clothing may be a two-dimensional image or a three-dimensional image, and the present disclosure is not limited herein. Of course, in order to improve the fitting effect of the virtual fitting, optionally the image of the target piece of clothing is a three-dimensional image.

Step 102: combining the image of the target piece of clothing with a body feature image of a user, to obtain a fitting image of the user wearing the target piece of clothing.

It should be noted that, the body feature image of the user may a human body model indicating a bodily form and physical characteristic of the user, and the body feature image may be acquired by a simulation based on muscle or skeleton data of the user. In addition, the body feature image of the user may be a two-dimensional image or a three-dimensional image, and the present disclosure is not limited herein.

Based on the above, in the case that the image of the target piece of clothing acquired in Step 101 is a two-dimensional image, in order to facilitate the combination, the image of the target piece of clothing and the body feature image of the user, the body feature image in Step 102 may be a two-dimensional image. To be specific, the two-dimensional image of the target piece of clothing may be superimposed to the two-dimensional body feature image, so as to achieve the above combination to acquire the above virtual fitting image.

Similarly, in the case that the image of the target piece of clothing acquired in Step 101 is a three-dimensional image, in order to facilitate the combination, the image of the target piece of clothing and the body feature image of the user, the body feature image in Step 102 may be a three-dimensional image. To be specific, regions of the three-dimensional body feature image and corresponding regions of the three-dimensional image of the target piece of clothing may be marked with icons respectively through computer software, and then, based on a mapping between the icons on marked the body feature image and the icons marked on the image of the target piece of clothing, a certain region of the image of the target piece of clothing is superimposed to the region of the body feature image which meets the above mapping, so as to achieve the above combination to acquire the above virtual fitting image.

Step 103: displaying the fitting image.

To sum up, when the user finds a desired piece of clothing, the user may take the piece of clothing as a target piece of clothing and acquire the characteristic data thereof, so as to acquire an image of the target piece of clothing based on the characteristic data. Next, the image of the target piece of clothing is combined with a body feature image of the user, so as to obtain a fitting image of the user wearing the target piece of clothing. At last, the fitting image which shows the actual fitting effect by simulation is displayed. As such, based on the above method, the user may see the virtual fitting image of the user wearing the target piece of clothing without trying on the target piece of clothing. Therefore, when the user finds many target pieces of clothing, the user does not need to try on the target clothing actually, thereby saving the time and energy of the user.

It should be noted that, when the user finds many desired pieces of clothing and takes them as the target clothing, it is able to acquire the characteristic data of only one target piece of clothing in the above Step 101, and the fitting of the desired pieces of clothing may achieved by repeating the above Step 101 to Step 103 over and over again.

Alternatively, it is able to acquire the characteristic data of many target pieces of clothing respectively in the above Step 101, and then, by repeating the above Step 102 over and over again, each of the virtual images of the target pieces of clothing may be combined with the body feature image to acquire a plurality of fitting images. In this case, the above fitting images may be displayed in sequence or simultaneously in the above Step 103.

It can be seen from the above description that, prior to Step 103, the user needs to determine the target piece of clothing so as to fit the same virtually. However, along with the improvement of living level, there are more and more types, styles and brands of clothing, so that the users may select based on their own preference the target clothing from many pieces of clothing. As a result, the time cost of selecting clothing may be increased.

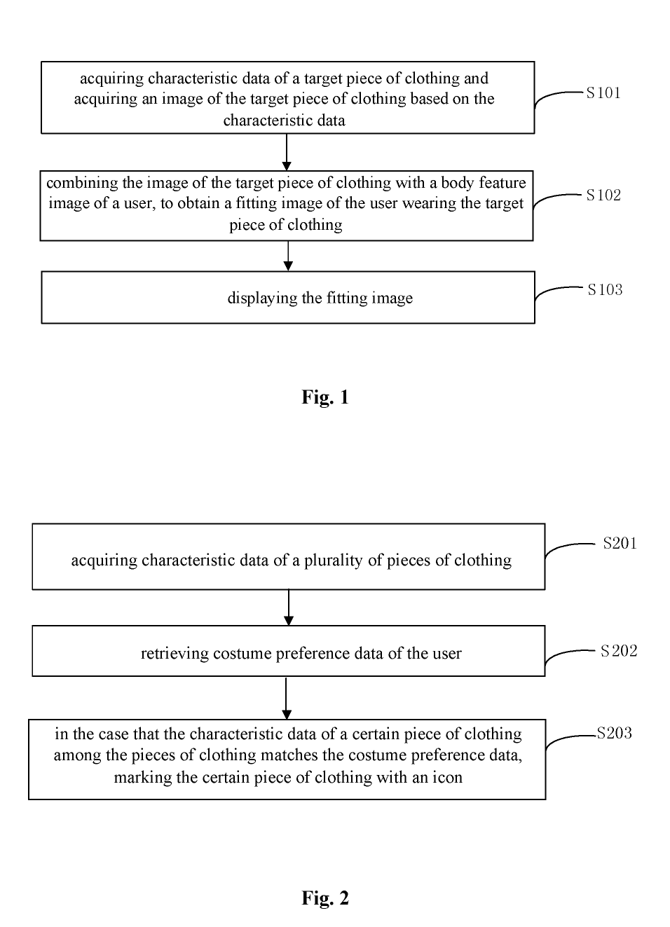

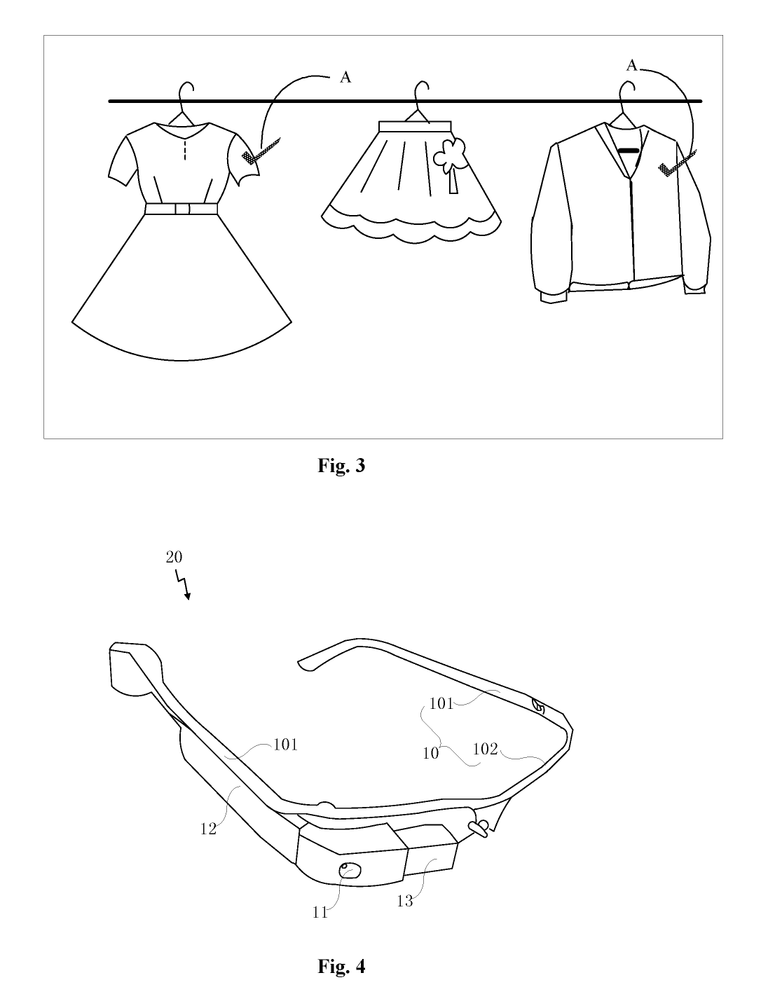

In view of this, prior to the above Step 101, as shown in FIG. 2, the method in at least one embodiment of the present disclosure further includes:

Step 201: acquiring characteristic data of a plurality of pieces of clothing.

To be specific, the characteristic data of all the clothing in a clothing shop of a shopping mall may be acquired.

Step 202: retrieving costume preference data of the user.

It should be noted that, the costume preference data includes a type, a type and the preferred color of the clothing.

In addition, the sequence of the above Step 201 and Step 202 is not limited, or the above Step 201 and Step 202 may be performed simultaneously.

Step 203: in the case that the characteristic data of a certain piece of clothing among the pieces of clothing matches the costume preference data, marking the certain piece of clothing with an icon A shown in FIG. 3. In this case, the user may select the target clothing from the clothing marked with the icons A. The user may take all of or a part of the clothing marked with the icons A as shown in FIG. 3 as the target clothing, so as to determine the above target clothing and perform Step 101.

It should be noted that, when the user wears a wearable device, the above icons A may be displayed on a display screen of the wearable device.

In addition, the costume preference data may include one clothing characteristic (e.g., the costume preference data indicates that the user prefers blue). Moreover, the costume preference data may be combined of a plurality of clothing characteristics (e.g., costume preference data indicates that the user prefers a blue dress or a black high-heeled shoes), and that is not limited herein. Optionally, the costume preference data is combined of 2 to 3 clothing characteristics. As such, when the clothing characteristic of the costume preference data is less than 2, there may be so many pieces of clothing marked with the icons A that the user may select from a large range of choice, and the time cost of selecting the clothing may be increased. When the clothing characteristics of the costume preference data are more than 3, the range of choice may be small.

To sum up, based on the above Step 201 to Step 203, it is able to mark the clothing according to the user's preference, so as to achieve a smart clothing recommendation. Therefore, the user does not need to select many pieces of clothing one by one, and thereby the user may determine the target clothing rapidly.

It can be seen from the above description, that the user may determine the target clothing rapidly based on the costume preference data. Based on this, along with a change of a working condition, a living environment or an age of the user, the costume preference of the user may change accordingly. Therefore, in order to update the costume preference data timely, the method further includes, subsequent to Step 103, receiving a storage instruction from the user, and storing the characteristic data of the target piece of clothing in the fitting image as costume preference data of the user.

It should be noted that, the storage instruction from the user refers to: the user may send the storage instruction when the user is satisfied with the target clothing after viewing the fitting image, so as to store the characteristic data of the target clothing and update the costume preference data; or the user may send the storage instruction when the user is satisfied with the target clothing after viewing the fitting image and determines to buy the target clothing, so as to store the characteristic data of the target clothing. As such, by updating the costume preference data, the costume preference data may become more matched with the user's preference, thereby improving an accuracy of the smart clothing recommendation.

Next, when the target clothing is determined, it is able to acquire an image of the target piece of clothing based on the characteristic data in Step 101. Next, the acquisition of the image of the target piece of clothing based on different types of characteristic data will be illustrated.

In the case that the characteristic data of the target piece of clothing is a trademark or a two-dimensional code, Step 101 further includes: scanning the trademark or the two-dimensional code, and retrieving an image of the clothing matching the trademark or the two-dimensional code. For example, when the user wears a smart wearable device which may be installed with an application software provided by the clothing seller, the smart wearable device may scan the trademark or the two-dimensional code through its own camera, and the application software may identify the trademark or the two-dimensional code and retrieve an image of the clothing matching the trademark or the two-dimensional code from a remote server, and then generate a virtual fitting image and display the same. Alternatively, when the user's mobile terminal (e.g., a cell phone or a tablet PC) is installed with the above application software, the mobile terminal may scan the trademark or the two-dimensional code and acquire the fitting image by identifying the trademark or the two-dimensional code, and then generate a virtual fitting image and display the same. As such, it is able to acquire, only by identifying the trademark or the two-dimensional code, the image of the target piece of clothing matching the characteristic data.

Taking another example, in the case that the characteristic data of the target piece of clothing is a color and a size of the target piece of clothing, the acquiring the image of the target piece of clothing based on the characteristic data in Step 101 further includes: generating the image of the target piece of clothing based on the characteristic data. To be specific, a depth camera may be arranged on a smart wearable device or a mobile terminal, and the depth camera may generate, based on the color and the size of the target piece of clothing, a depth image of the target piece of clothing indicating depth related information and generate a three-dimensional model of the target piece of clothing based on the depth image.

A pair of virtual fitting glasses 20, as shown in FIG. 4, is further provided in at least one embodiment of the present disclosure, including a glasses bracket 10. The glasses bracket 10 includes two glasses temples 101 and a glasses frame 102 between the two glasses temples 101. In addition, the pair of virtual fitting glasses 20 further includes an acquisition unit 11, a processor 12 and a display 13 arranged on the glasses bracket 10.

The acquisition unit 11 is arranged at a side of the glasses bracket 10 away from user's eyes, and configured to acquire characteristic data of a target piece of clothing and acquire an image of the target piece of clothing based on the characteristic data.

The processor 12 is connected to the acquisition unit 11, and configured to combine the image of the target piece of clothing with a body feature image of a user to obtain a fitting image of the user wearing the target piece of clothing. Because the body feature image of the user may relate to a bodily form characteristic and a physical characteristic of the user and the above characteristics are privacies, the body feature image of the user may be stored by a storage arranged on the glasses bracket 10, so as to manage the personal information of the user.

The display 13 is connected to the processor 12 and configured to display the fitting image.

To sum up, when trying on the clothing, the user may wear the above pair of virtual fitting glasses. In this case, when the user finds a desired piece of clothing, the user may take the piece of clothing as a target piece of clothing and acquire the characteristic data thereof. The acquisition unit of the pair of virtual fitting glasses may acquire characteristic data of a target piece of clothing and acquire an image of the target piece of clothing based on the characteristic data. Next, the processor may combine the image of the target piece of clothing with a body feature image of the user, so as to obtain a fitting image of the user wearing the target piece of clothing and display the fitting image which shows the actual fitting effect by simulation. As such, by the pair of virtual fitting glasses, the user may see the virtual fitting image of the user wearing the target piece of clothing without trying on the target piece of clothing. Therefore, when the user finds many target pieces of clothing, the user does not need to try on the target clothing actually, thereby saving the time and energy of the user.

It should be noted that, when the user finds many desired pieces of clothing and takes them as the target clothing, the acquisition unit 11 of the virtual fitting glasses 20 may acquire the characteristic data of one of the target pieces of clothing and acquire the image of the above target pieces of clothing, and then the processor 12 may combine the image of the target piece of clothing with the body feature image of the user, to obtain a fitting image of the user wearing the target piece of clothing and display the same through the display 13.

Alternatively, the acquisition unit 11 of the virtual fitting glasses 20 may acquire the characteristic data of many target pieces of clothing respectively and acquire the image of each of the target pieces of clothing, and then the processor 12 may combine each of the virtual images of the target pieces of clothing with the body feature image to acquire a plurality of fitting images. The display 13 may display the fitting images in sequence or simultaneously.

However, along with the improvement of living level, there are more and more types, styles and brands of clothing, so that the users may select based on their own preference the target clothing from many pieces of clothing. As a result, the time cost of selecting clothing may be increased.

In view of this, a storage may be arranged on the glasses bracket 10 to store therein costume preference data of the user, so as to achieve a smart clothing recommendation based on the costume preference data.

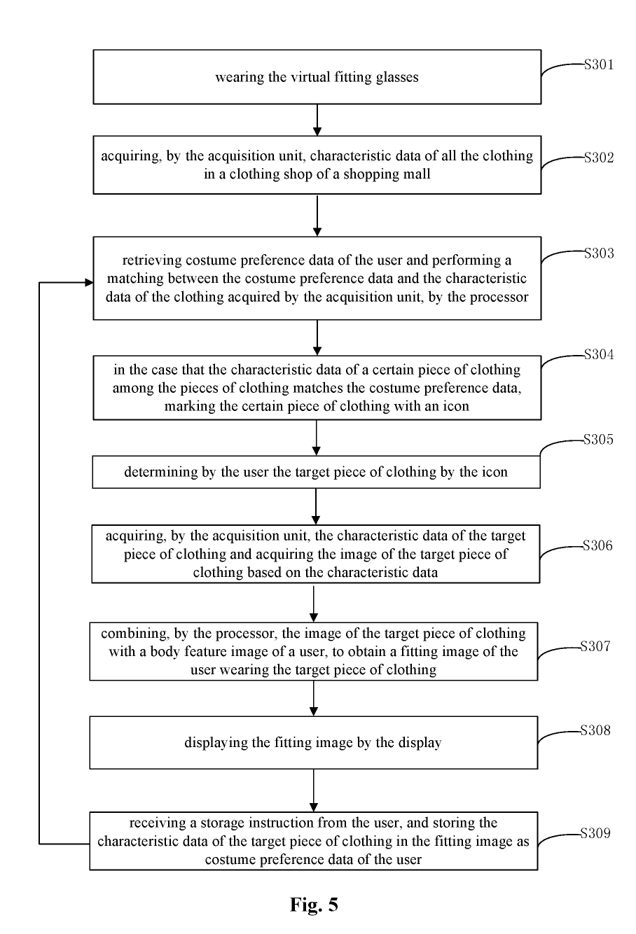

Next, the smart clothing recommendation by the virtual fitting glasses 20 will be illustrated. As shown in FIG. 5, the smart clothing recommendation includes:

Step 301: wearing the virtual fitting glasses 20.

It should be noted that, the virtual fitting glasses 20 may be provide with a starting switch. When user tries on the clothing virtually through the virtual fitting glasses 20, the user may power on the virtual fitting glasses 20 by pressing the starting switch.

Alternatively, the virtual fitting glasses 20 may be provided with a positioner arranged on the glasses bracket 10 configured to detect a geographic position of the user. When the positioner determines that the user is in a shopping mall, positioner may send a starting signal to the starting switch to power on the virtual fitting glasses, without any manual operation.

The positioner may further include an acceleration sensor, a gyroscope and a magnetism sensor. When the user is moving, the acceleration sensor may detect an accelerated speed of the virtual fitting glasses 20, and the gyroscope may detect an angular velocity of the virtual fitting glasses 20. The magnetism sensor may detect intensity and a direction of a magnetic field around the user. Therefore, it is able to position the user through the acceleration sensor, the gyroscope and the magnetism sensor.

Step 302: acquiring, by the acquisition unit 11, characteristic data of all the clothing in a clothing shop of a shopping mall.

Step 303: retrieving costume preference data of the user and performing a matching between the costume preference data and the characteristic data of the clothing acquired by the acquisition unit 11, by the processor 12.

Step 304: in the case that the characteristic data of a certain piece of clothing among the pieces of clothing matches the costume preference data, marking the certain piece of clothing with an icon A at a position of the display showing the certain piece of clothing.

Step 305: determining by the user the target piece of clothing by the icon A.

The user may take all of or a part of the clothing marked with the icons A as shown in FIG. 3 as the target clothing, so as to enable the acquisition unit 11 to acquire the characteristic data of the target clothing.

As such, by the virtual fitting glasses 20 storing the costume preference data, it is able to mark the clothing according to the user's preference, so as to achieve a smart clothing recommendation. Therefore, the user does not need to select many pieces of clothing one by one, and thereby the user may determine the target clothing rapidly.

It should be noted that, the costume preference data may include one clothing characteristic (e.g., the costume preference data indicates that the user prefers blue). Moreover, the costume preference data may be combined of a plurality of clothing characteristics (e.g., costume preference data indicates that the user prefers a blue dress or a black high-heeled shoes), and that is not limited herein. Optionally, the costume preference data is combined of 2 to 3 clothing characteristics. As such, when the clothing characteristic of the costume preference data is less than 2, there may be so many pieces of clothing marked with the icons A that the user may select from a large range of choice, and the time cost of selecting the clothing may be increased. When the clothing characteristics of the costume preference data are more than 3, the range of choice may be small.

Step 306: acquiring, by the acquisition unit 11, the characteristic data of the target piece of clothing and acquiring the image of the target piece of clothing based on the characteristic data.

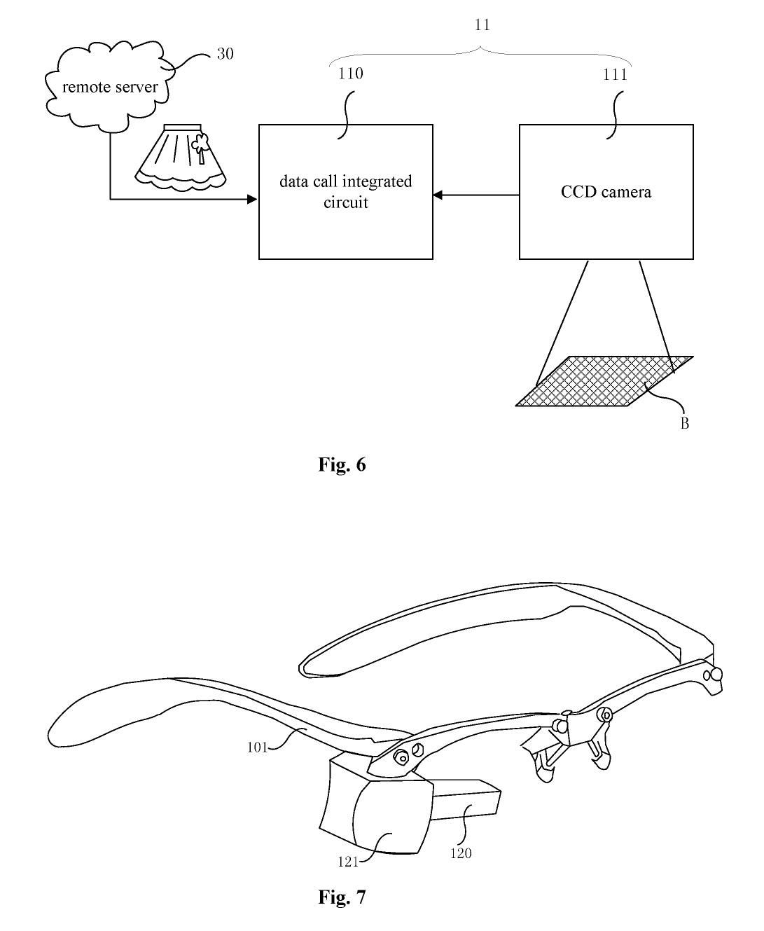

To be specific, as shown in FIG. 6, the acquisition unit 11 includes a data call integrated circuit 110 and a charge-coupled device (CCD) camera 111 or a complementary metal oxide semiconductor (CMOS) camera connected to the data call integrated circuit 110. The CCD camera 111 is configured to scan a trademark or a two-dimensional code of the target piece of clothing.

The data call integrated circuit 110 is configured to identify the trademark of the two-dimensional code and retrieve, based on the trademark or the two-dimensional code, an image of the clothing matching the trademark or the two-dimensional code from a remote server 30.

Taking another example, the acquisition unit 11 further includes a depth camera configured to acquire a color and a size of the target piece of clothing and generate the image of the target piece of clothing based on the color and the size of the target piece of clothing. The depth camera may generate, based on the color and the size of the target piece of clothing, a depth image of the target piece of clothing indicating depth related information and generate a three-dimensional model of the target piece of clothing based on the depth image.

Step 307: combining, by the processor 12, the image of the target piece of clothing with a body feature image of a user, to obtain a fitting image of the user wearing the target piece of clothing.

Step 308: displaying the fitting image by the display 13.

It should be noted that, when the image of the target piece of clothing acquired by the acquisition unit 11 based on the characteristic data is a two-dimensional image, the processor 12 may combine the image of the target piece of clothing with a two-dimensional body feature image, so as to display a two-dimensional fitting image by the display 13. Similarly, when the image of the target piece of clothing acquired by the acquisition unit 11 based on the characteristic data is a three-dimensional image, the processor 12 may combine the image of the target piece of clothing with a three-dimensional body feature image, so as to display a three-dimensional fitting image by the display 13.

Next, the structure of the virtual fitting glasses 20 displaying the two-dimensional or three-dimensional image will be described hereinafter.

For example, in the case that the fitting image is a two-dimensional image, as shown in FIG. 7, the display 13 includes a transparent prism 120 and a projector 121 arranged on a glasses temple 101 of the glasses bracket 10.

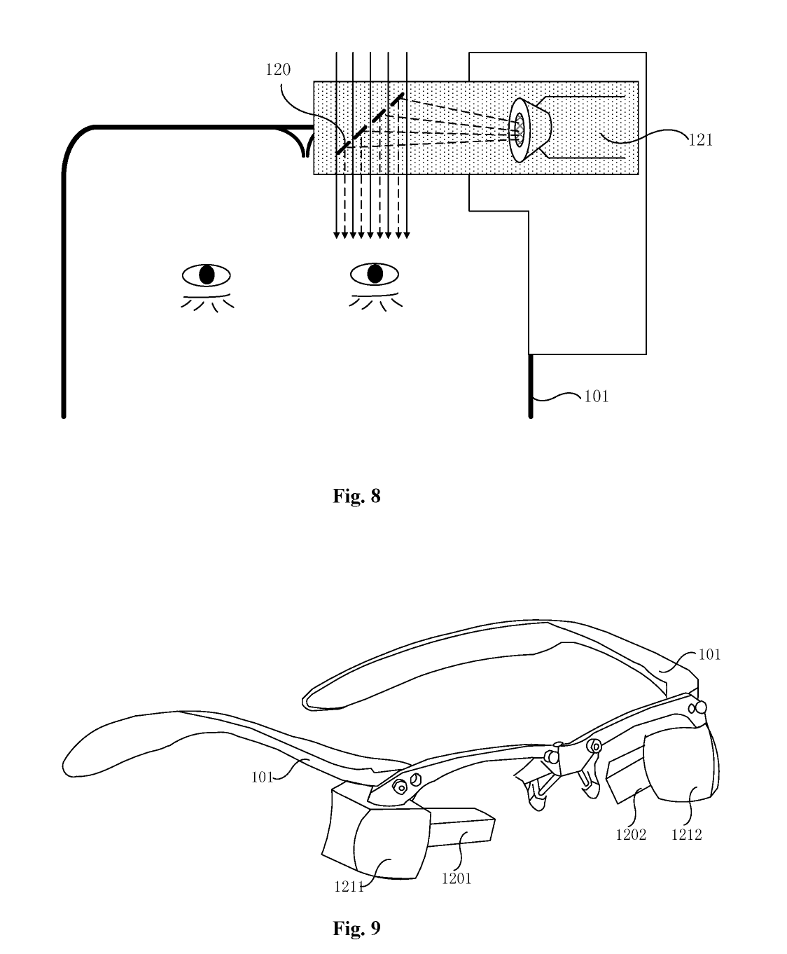

In this case, as shown in FIG. 8, the projector 121 may project the fitting image onto the transparent prism 120 along a direction of the dotted line in FIG. 8 and then project through the transparent prism 120 the fitting image to the user's eye. Based on this, the ambient light beams may enter into the user's eye along a direction of the full line in FIG. 8 through the transparent prism 120. Therefore, the user may see the background image when viewing the virtual image, thereby achieving an augmented reality (AR).

Taking another example, as shown in FIG. 9, the display 13 includes a first transparent prism 1201 and a first projector 1211 arranged on one glasses temple of the glasses bracket 10 and a second transparent prism 1202 and a second projector 1212 arranged on the other glasses temple 101 of the glasses bracket 10.

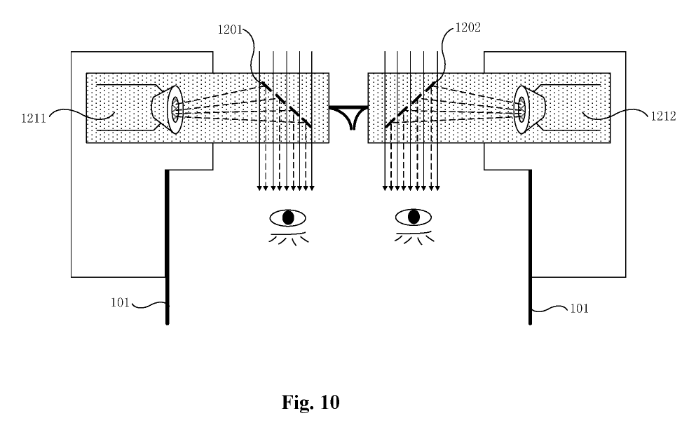

In this case, as shown in FIG. 10, the first projector 1211 may project a left-eye image of the fitting image onto the first transparent prism 1201 to project via the first transparent prism 1201 the left-eye image to a user's left eye, and the second projector 1212 may project a right-eye image of the fitting image onto the second transparent prism 1202 to project via the second transparent prism 1202 the right-eye image to a user's right eye. As such, the user's left eye may merely see the left-eye image projected through the first transparent prism 1201, and the user's right eye may merely see the right-eye image projected through the second transparent prism 1202, so the user's brain may combine the two images to generate a three-dimensional fitting image. In addition, the ambient light beams may enter into the user's eyes through the first transparent prism 1201 and the second transparent prism 1202 along the directions of the full lines. Therefore, the user may see the background image when viewing the virtual images, thereby achieving an AR.

Step 309: receiving a storage instruction from the user, and storing the characteristic data of the target piece of clothing in the fitting image as costume preference data of the user.

It should be noted that, the storage instruction from the user refers to: the user may send the storage instruction when the user is satisfied with the target clothing after viewing the fitting image, so as to store the characteristic data of the target clothing and update the costume preference data; or the user may send the storage instruction when the user is satisfied with the target clothing after viewing the fitting image and determines to buy the target clothing, so as to store the characteristic data of the target clothing. As such, by updating the costume preference data, the costume preference data may become more matched with the user's preference, thereby improving an accuracy of the smart clothing recommendation.

A virtual fitting system is provided in at least one embodiment of the present disclosure, including the above pair of virtual fitting glasses 20 and a remote server 30 as shown in FIG. 6 connected to the pair of virtual fitting glasses 20. The acquisition unit 11 of the virtual fitting glasses 20 may scan a two-dimensional code B (or a trademark) of the clothing and acquire an image of the target piece of clothing based on the two-dimensional code B from a remote server 30. To be specific, as shown in FIG. 6, the acquisition unit 11 includes a data call integrated circuit 110 and a CCD camera 111 or a CMOS camera connected to the data call integrated circuit 110. The CCD camera 111 may scan a two-dimensional code B (or a trademark) of the target piece of clothing. The data call integrated circuit 110 is configured to identify the trademark of the two-dimensional code and retrieve, based on the two-dimensional code, an image of the clothing matching the trademark or the two-dimensional code from a remote server 30.

In this case, the processor may combine the image of the target piece of clothing with a body feature image of the user, so as to obtain a fitting image of the user wearing the target piece of clothing and display the fitting image which shows the actual fitting effect by simulation. As such, by the pair of virtual fitting glasses, the user may see the virtual fitting image of the user wearing the target piece of clothing without trying on the target piece of clothing. Therefore, when the user finds many target pieces of clothing, the user does not need to try on the target clothing actually, thereby saving the time and energy of the user.

It should be appreciated that, the present disclosure may be provided as a method, a system or a computer program product, so the present disclosure may be in the form of full hardware embodiments, full software embodiments, or combinations thereof. In addition, the present disclosure may be in the form of a computer program product implemented on one or more computer-readable storage mediums (including but not limited to disk memory, CD-ROM and optical memory) including computer-readable program codes.

The above are merely some embodiments of the present disclosure. A person skilled in the art may make further modifications and improvements without departing from the principle of the present disclosure, and these modifications and improvements shall also fall within the scope of the present disclosure.

What is claimed is:

1. A virtual fitting method, comprising:
acquiring characteristic data of a target piece of clothing and acquiring an image of the target piece of clothing based on the characteristic data;
combining the image of the target piece of clothing with a body feature image of a user, to obtain a fitting image of the user wearing the target piece of clothing; and
displaying the fitting image.

2. The virtual fitting method according to claim 1, wherein prior to acquiring the characteristic data of the target piece of clothing and acquiring the image of the target piece of clothing based on the characteristic data, the method further comprises:
acquiring characteristic data of a plurality of pieces of clothing;
retrieving costume preference data of the user; and
in the case that the characteristic data of a certain piece of clothing among the pieces of clothing matches the costume preference data, marking the certain piece of clothing with an icon.

3. The virtual fitting method according to claim 1, wherein in the case that the characteristic data of the target piece of clothing is a trademark or a two-dimensional code, the acquiring the characteristic data of the target piece of clothing and acquiring the image of the target piece of clothing based on the characteristic data comprises:
scanning the trademark or the two-dimensional code, and retrieving an image of the clothing matching the trademark or the two-dimensional code from a remote server.

4. The virtual fitting method according to claim 1, wherein in the case that the characteristic data of the target piece of clothing is a color and a size of the target piece of clothing, the acquiring the image of the target piece of clothing based on the characteristic data comprises: generating the image of the target piece of clothing based on the characteristic data.

5. The virtual fitting method according to claim 1, wherein subsequent to displaying the fitting image, the method further comprises:
receiving a storage instruction from the user, and storing the characteristic data of the target piece of clothing in the fitting image as costume preference data of the user.

6. A pair of virtual fitting glasses, comprising a glasses bracket and an acquisition unit, a processor and a display arranged on the glasses bracket, wherein
the acquisition unit is arranged at a side of the glasses bracket away from user's eyes, and configured to acquire characteristic data of a target piece of clothing and acquire an image of the target piece of clothing based on the characteristic data;
the processor is connected to the acquisition unit, and configured to combine the image of the target piece of clothing with a body feature image of a user to obtain a fitting image of the user wearing the target piece of clothing; and
the display is connected to the processor and configured to display the fitting image.

7. The pair of virtual fitting glasses according to claim 6, further comprising a storage arranged on the glasses bracket and configured to store therein the body feature image of the user and costume preference data of the user.

8. The pair of virtual fitting glasses according to claim 6, wherein the fitting image is a two-dimensional image, the display comprises a transparent prism and a projector arranged on a glasses temple of the glasses bracket, and the projector is configured to project the fitting image onto the transparent prism to project via the transparent prism the fitting image to the user eye.

9. The pair of virtual fitting glasses according to claim 6, wherein the fitting image is a three-dimensional image, the display comprises a first transparent prism and a first projector arranged on one glasses temple of the glasses bracket and a second transparent prism and a second projector arranged on the other glasses temple of the glasses bracket;
the first projector is configured to project a left-eye image of the fitting image onto the first transparent prism to project via the first transparent prism the left-eye image to a user's left eye; and
the second projector is configured to project a right-eye image of the fitting image onto the second transparent prism to project via the second transparent prism the right-eye image to a user's right eye.

10. The pair of virtual fitting glasses according to claim 6, further comprising a positioner arranged on the glasses bracket and configured to detect a geographic position of the user.

11. The pair of virtual fitting glasses according to claim 6, wherein the acquisition unit comprises a data call integrated circuit and a charge-coupled device (CCD) camera or a complementary metal oxide semiconductor (CMOS) camera connected to the data call integrated circuit;
the CCD camera or the CMOS camera is configured to scan a trademark or a two-dimensional code of the target piece of clothing; and
the data call integrated circuit is configured to retrieve, based on the trademark or the two-dimensional code of the target piece of clothing, an image of the clothing matching the trademark or the two-dimensional code from a remote server.

12. The pair of virtual fitting glasses according to claim 6, wherein the acquisition unit comprises a depth camera configured to acquire a color and a size of the target piece of clothing and generate the image of the target piece of clothing based on the color and the size of the target piece of clothing.

13. The pair of virtual fitting glasses according to claim 10, further comprising a starting switch, wherein the positioner is further configured to send a starting signal to the starting switch to power on the pair of virtual fitting glasses.

14. The pair of virtual fitting glasses according to claim 10, wherein the positioner further comprises an acceleration sensor, a gyroscope and a magnetism sensor.

15. The pair of virtual fitting glasses according to claim 12, wherein the depth camera is configured to generate, based on the color and the size of the target piece of clothing, a depth image of the target piece of clothing indicating depth related information.

16. A virtual fitting system comprising the pair of virtual fitting glasses according to claim 6 and a remote server connected to the pair of virtual fitting glasses.
